(19) United States
(12) Patent Application Publication
(10) Pub. No.: US 2024/0366973 A1
(43) Pub. Date: Nov. 7, 2024

(54) HEAD WEARABLE AIR PURIFIER

(71) Applicant: Dyson Technology Limited, Wiltshire (GB)

(72) Inventors: Jake John READ, Bristol (GB); Richard John FOX, Bristol (GB); Mark Joseph STANIFORTH, Singapore (SG); Mark Paul FOULGER, Bristol (GB); David James HILL, Bristol (GB); Howard Shi-How CHENG, Bristol (GB)

(21) Appl. No.: 18/689,302

(22) PCT Filed: Aug. 26, 2022
(86) PCT No.: PCT/GB2022/052200

§ 371 Date: Mar. 5, 2024

(30) Foreign Application Priority Data
Sep. 6, 2021 (GB) 2112657.8

(51) Int. Cl. A62B 18/08; A62B 7/10; A62B 18/02

(52) U.S. Cl. CPC A62B 18/084; A62B 7/10; A62B 18/025

(57) ABSTRACT

A head wearable air purifier includes a headgear, an air purifier assembly supported by the headgear, a nozzle assembly and a mask body. The air purifier assembly includes a filter and an airflow generator for generating an airflow through the filter. The nozzle assembly is configured to extend in front of a face of a wearer in use. The nozzle assembly includes an inlet aperture configured to receive a filtered airflow from the air purifier assembly, and an air outlet for emitting the filtered airflow from the nozzle assembly. The mask body detachably connects to the nozzle assembly and defines a cavity for receiving a mouth and/or nose of the wearer. The cavity is in fluid communication with the air outlet.

### FIELD OF THE INVENTION

The present invention relates to a head wearable air purifier.

### BACKGROUND OF THE INVENTION

Air pollution is an increasing problem and a variety of air pollutants have known or suspected harmful effects on human health. The adverse effects that can be caused by air pollution depend upon the pollutant type and concentration, and the length of exposure to the polluted air. For example, high air pollution levels can cause immediate health problems such as aggravated cardiovascular and respiratory illness, whereas long-term exposure to polluted air can have permanent health effects such as loss of lung capacity and decreased lung function, and the development of diseases such as asthma, bronchitis, emphysema, and possibly cancer.

### SUMMARY OF THE INVENTION

According to a first aspect of the present invention there is provided a head wearable air purifier comprising a headgear; an air purifier assembly supported by the headgear, the air purifier assembly comprising a filter and an airflow generator for generating an airflow through the filter; a nozzle assembly configured to extend in front of a face of a wearer in use, the nozzle assembly comprising an inlet aperture configured to receive a filtered airflow from the air purifier assembly, and an air outlet for emitting the filtered airflow from the nozzle assembly; and a mask body detachably connected to the nozzle assembly, the mask body defining a cavity for receiving a mouth and/or nose of the wearer, the cavity in fluid communication with the air outlet.

By having a mask body connected to the nozzle assembly, a greater proportion of the airflow emitted from the air outlet may be provided to the mouth and/or nose of the wearer relative to a non-contact arrangement, for example an arrangement where the nozzle assembly is spaced from the mouth and/or nose of a wearer. As the mask body is detachably connected to the nozzle assembly, the wearer may be able to remove the mask body when not required and receive a filtered airflow from the nozzle assembly directly, which may increase the comfort of the wearer as the nose and/or mouth of the wearer may not be covered. Furthermore, this may facilitate cleaning of the mask body.

When the mask body is disconnected from the nozzle assembly, the nozzle assembly may be configured such that the air outlet delivers the filtered airflow to a mouth and/or nasal region of the wearer in use without contacting the face of the wearer. This may provide an arrangement with increased comfort for the wearer, for example relative to an arrangement where the nozzle assembly contacts the face of the wearer in use.

The mask body may comprise a further filter. As a result, air exhaled by the wearer in use may be filtered before being released into the surrounding environment. This may reduce the risk of spread of pathogens from the wearer to the surrounding environment relative to a non-contact arrangement. The further filter may be removable. This may facilitate cleaning of the further filter or enable the filter to be replaced.

The mask body may comprise a locating feature configured to detachably connect to the nozzle assembly. For example, the locating feature may be configured to form an interference fit with a portion of the nozzle assembly to detachably connect the locating feature to the nozzle assembly.

This may provide a simple mechanism for connecting the mask body to the nozzle assembly that may allow the wearer to quickly and easily remove and connect the mask body. In some examples, the portion of the nozzle assembly may comprise a flange and the locating feature may comprise a slot configured to receive the flange. Friction between the flange and the slot may form the interference fit. The locating feature may be configured to detachably connect to the nozzle assembly such that the mask body overlies the air outlet of the nozzle assembly.

The nozzle assembly may comprise a further locating feature configured to contact the nozzle assembly when the locating feature is connected to the nozzle assembly. This may aid the wearer in positioning the mask body relative to the nozzle assembly, and may decrease the likelihood, relative to an arrangement having only one locating feature, of the wearer incorrectly locating the mask body relative to the nozzle assembly. Incorrectly locating the mask body relative to the nozzle assembly may result in an increased proportion of the airflow generated by the airflow generator not entering the cavity, which may decrease the performance of the head wearable air purifier. The mask body may be correctly located relative to the nozzle assembly when the mask body overlies the air outlet.

The further locating feature may be configured to detachably connect to the nozzle assembly. For example, the further locating feature may be configured to form an interference fit with a further portion of the nozzle assembly to detachably connect the further locating feature to the nozzle assembly. This may provide a simple mechanism for further securing the mask body to the nozzle assembly that may allow the wearer to quickly and easily remove and connect the mask body.

In some examples, the further portion of the nozzle assembly may comprise a further flange, and the further locating feature may comprise a further slot configured to receive the flange. Friction between the further flange and the further slot may form the interference fit. In other examples, the further portion of the nozzle assembly may comprise the further flange, and the further locating feature may comprise a projection configured to contact the further flange in use. The projection may sit on top of the further flange, and friction between the further flange and the projection may form the interference fit. This may provide a method for further securing the mask body whilst minimising the increase in difficulty for the wearer to connecting the mask body to the nozzle assembly compared to, for example, the further locating feature comprising a slot.

The mask body may comprise a flow guide for inhibiting the airflow emitted from the air outlet from leaking around the mask body. This may increase the proportion of the airflow generated by the airflow generator entering the cavity relative to an arrangement without a flow guide. This may enable the amount of airflow generated by the airflow generator to be reduced whilst maintaining the amount of filtered airflow reaching the cavity, which may reduce the energy draw from batteries of the of the head wearable air purifier and increase the operational duration of the head wearable air purifier. The flow guide may comprise projections projecting from the nozzle assembly facing side of the mask body that surround or partially overlie the air outlet. The flow guide may be configured to conform to the shape of the nozzle assembly.

The flow guide may comprise a Shore A Durometer of between 70 and 90. A lower Shore A durometer may aid conformance of the flow guide to the shape of the nozzle assembly which may increase the proportion of the airflow entering the cavity. However, too low a Shore A Durometer may result in the airflow deforming the flow guide and reducing the proportion of the airflow entering the cavity. The aforementioned range may provide a good compromise between these competing factors. The flow guide may comprise silicone.

The mask body may comprise a seal for sealing with a face of the wearer in use. This may inhibit leakage of exhaled air from between the mask body and the face of the wearer. The seal may extend about a perimeter of the mask body. The seal may comprise a resiliently deformable material, which may deform upon contact with the face of the wearer in use.

The seal may comprise a Shore A durometer of between 30 and 50. A lower Shore A Durometer may aid conformance of the seal to the face of the wearer and increase the comfort of the wearer.

The mask body may comprise an open cell foam. The mask body may be configured such that in use the airflow is directed through the open cell foam. The open cell foam may filter the airflow and exhaled air whilst also providing sufficient rigidity to hold the shape of the mask body.

The mask body may comprise a layer of fabric. This may be more aesthetically pleasing to the user and increase the robustness of the mask body during cleaning, for example in a washing machine, relative to an arrangement without a layer of fabric. For example, a layer of fabric wrapped around the open cell foam discussed previously. The layer of fabric may constitute a filter and thereby filter the exhaled air.

The mask body may comprise a deformable nose bridge configured to overlie the nose of the wearer in use. The deformable nose bridge may support the shape of the mask body. The deformable nose bridge may comprise at least one metal strip or wire.

The mask body may be configured such that a pressure drop of the airflow between the air outlet and the cavity is between 400 and 500 pascals in use. Such a pressure drop may ensure sufficient air reaches the cavity. The mask body may comprise a thickness and the foam may comprise a pore size such that the pressure drop of the airflow between the air outlet and the cavity is between 400 and 500 pascals.

The mask body may comprise at least one tab configured to retain a filter media in use. This may provide a convenient method for providing a filter to the mask body or additional filtration if the mask body already comprises a filter. Furthermore, this may enable the use of disposable filter media. In some examples, the further filter may be defined by a material of the mask body, and the filer media may be separate to the further filter. In other examples, the further filter may comprise the filter media. The tab may comprise a resiliently deformable material, which may aid the ease of insertion of filter media because the tab may be deformed to insert the filter media. In particular, the tab may comprise a Shore A Durometer of between 30 and 50. A lower Shore A Durometer may aid ease of insertion of the filter media, but too low a Shore A Durometer may result in the filter media becoming dislodged during use due to too low a retention force being exerted by the tab. The tab may be located on the side of the mask body facing the wearer in use. The mask body may comprise a plurality of tabs, which may further reduce the likelihood of the filter media becoming dislodged during use. The seal of the mask body may define the tab, which may aid the manufacturability of the mask body.

The nozzle assembly may be detachably connected to the air purifier assembly. As a result, the mask body may be attached and detached from the nozzle assembly without removing the headgear from a head of the wearer. This may increase the ease of use of the head wearable air purifier. Additionally, this may facilitate cleaning of the nozzle assembly.

The nozzle assembly may comprise an extension mechanism for controlling a length of the nozzle assembly. As the mask body may be connected to the nozzle assembly in use, the wearer may be able to adjust the nozzle assembly to achieve a secure and comfortable fit between the mask body and the face of the wearer. The extension mechanism may comprise a ratcheting mechanism and/or a telescoping mechanism.

The mask body may comprise an aperture having a diameter of at least 10 mm and configured to receive the airflow from the nozzle assembly in use. As a result, the proportion of the airflow generated by the airflow generator entering the cavity may be increased. This may enable the amount of airflow generated to be reduced whilst maintaining the amount of filtered airflow reaching the cavity, which may reduce the energy draw from batteries of the of the head wearable air purifier and increase the operational duration of the head wearable air purifier. The aperture may be in fluid communication with the cavity.

### BRIEF DESCRIPTION OF THE DRAWINGS

FIG. 1 is a is a front view of a head wearable air purifier with a mask body removed;

FIG. 2 is a cross-sectional view of the head wearable air purifier of FIG. 1 with a nozzle assembly and the mask body removed;

FIG. 3 is an underside view of the head wearable air purifier of FIG. 1 with a nozzle assembly detached and the mask body removed;

FIG. 4 is a rear perspective view of a nozzle assembly of the head wearable air purifier of FIG. 1;

FIG. 5 is a front perspective view of the mask body of the head wearable air purifier;

FIG. 6 is a front perspective view of the mask body connected to the nozzle assembly;

FIG. 7 is a rear perspective view of the mask body connected to the nozzle assembly;

FIG. 8 is a cross-sectional view of the mask body connected to the nozzle assembly;

FIG. 9 is a front perspective view of an alternative mask body and connection plate;

FIG. 10 is a perspective view of a further mask body; and

FIG. 11 is an exploded view of the further mask body of FIG. 10; and

FIG. 12 is a cross-sectional view of the further mask body connected to the nozzle assembly.

### DETAILED DESCRIPTION OF THE INVENTION

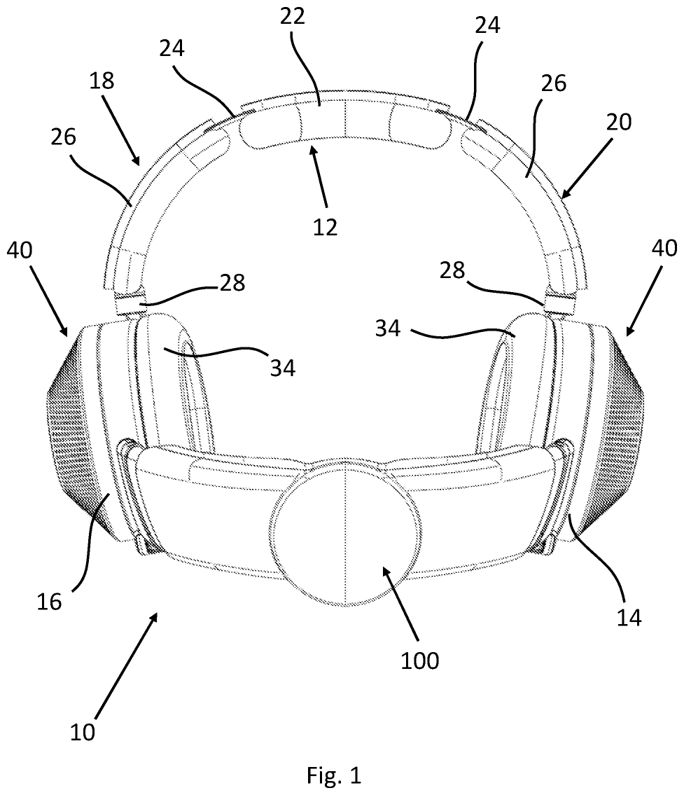

A head wearable air purifier, generally designated 10, is shown schematically in FIGS. 1, 2 and 3.

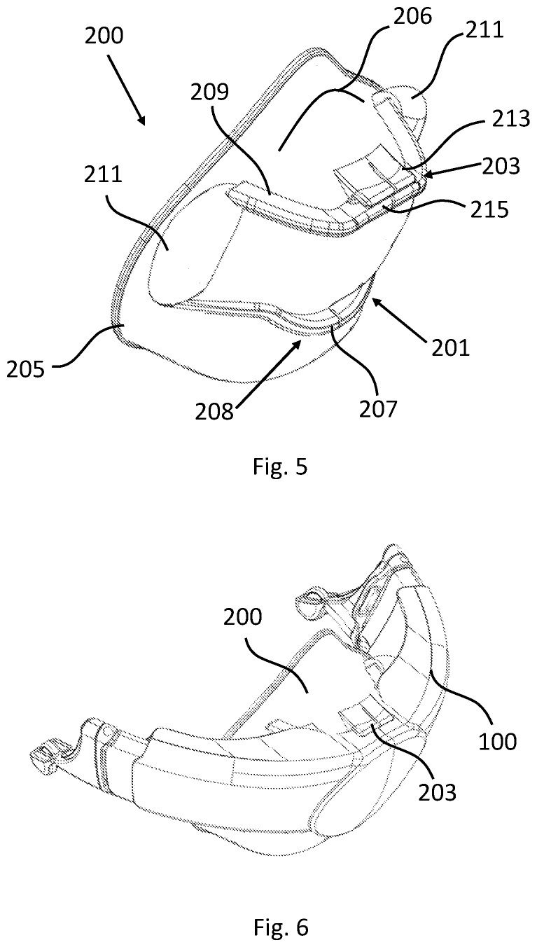

The head wearable air purifier 10 comprises a headgear 12, first 14 and second 16 purifier assembly housings, a nozzle assembly 100 and a detachably connected mask body 200 shown separately in FIGS. 5, 6 and 7.

The headgear 12 has the form of a headband, is generally elongate and arcuate in form, and is configured to overlie a top of a head of a wearer, and sides of the head of the wearer, in use. The headgear 12 has a first end portion 18, a second end portion 20, and a central portion 22. Each of the first 18 and second 20 end portions are connected to the central portion 22 by an extension mechanism. Each extension mechanism comprises an arm 24 that engages with teeth internal of the first 18 and second 20 end portions to form a ratchet mechanism that enables adjustment of the length of the headgear 12 by a wearer. To this end, the teeth, a spacing between the teeth and an opposing wall, or the arm 24 itself, may be sufficiently resilient to provide the required retention.

The first 18 and second 20 end portions of the headgear 12 each comprise a hollow housing 26. The hollow housing 26 defines a battery compartment for receiving one or more batteries therein. It will be appreciated that batteries may be removable from the hollow housing 26, or may be intended to be retained within the hollow housing 26 during normal use. Where the batteries are replaceable and intended to be removable from the hollow housing 26, the hollow housing 26 may, for example, comprise a releasable door or cover to enable access to the interior of the hollow housing 26. Where batteries are rechargeable and intended to be retained within the hollow housing 26 in normal use, the hollow housing 26, or indeed other components of the head wearable air purifier 10, may comprise at least one charge port to enable recharging of batteries.

The first 18 and second 20 end portions of the headgear 12 are connected to respective ones of the first 14 and second 16 purifier assembly housings. In some examples, the first 18 and second 20 end portions of the headgear 12 are connected to respective ones of the first 14 and second 16 purifier assembly housings such that relative movement is enabled between the first 18 and second 20 end portions of the headgear 12 and the respective first 14 and second 16 purifier assembly housings. As shown in FIG. 1, a gimbal arm 28 is used for such a connection, with swivel pins (not shown) located at either end of the gimbal arm 28, but it will be appreciated by a person skilled in the art that other forms of connection are possible. To enable electrical connection of batteries contained within the hollow housings 26 of the first 18 and second 20 end portions of the headgear to components internal of the first 14 and second 16 purifier assembly housings, the swivel pins 28 are hollow, for example to allow electrical wiring or the like to pass therethrough.

The first 14 and second 16 purifier assembly housings comprise ear cups such as those typically used for so-called “over-the-ear” headphones, which are generally hemi-spherical and hollow in form.

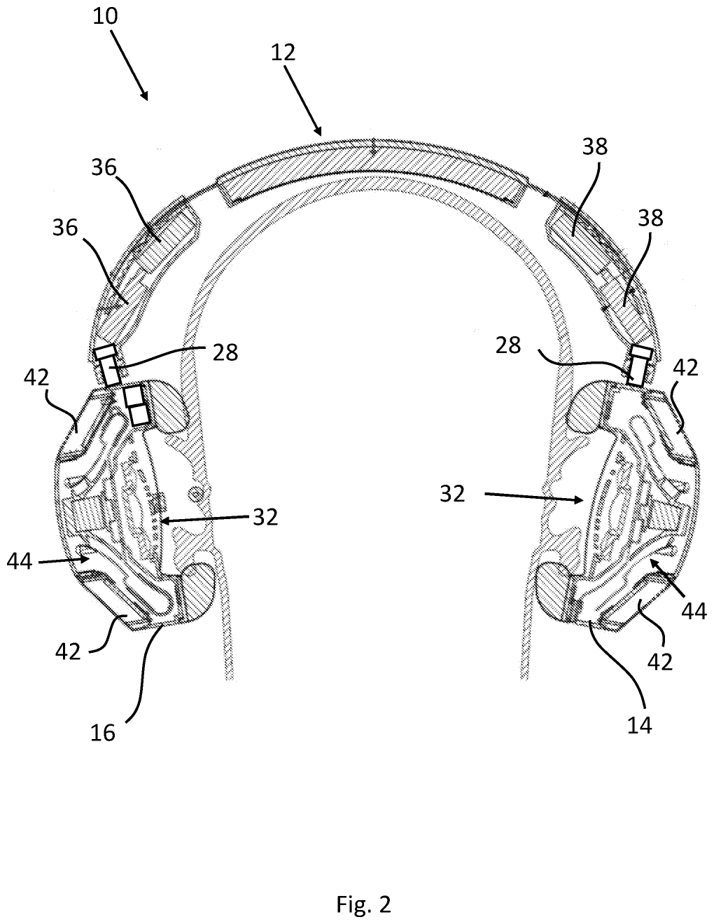

Each purifier assembly housing 14, 16 houses a speaker assembly 32, as shown in FIG. 2, and comprises annular padding 34 configured to surround an ear of a wearer of the head wearable air purifier 10. Details of the speaker assembly 32 are not pertinent to the present invention, and so will not be described here for the sake of brevity, but it will be recognised by a person skilled in the art that any appropriate speaker assembly may be chosen. In use, the speaker assemblies 32 received within the first 14 and second 16 purifier assembly housings are configured to receive power from all of the batteries 36, 38. Power transfer wiring (not shown) runs through the headgear 12 between the first 18 and second 20 end portions, for example through the central portion 22 and arms 24. Such an arrangement provides increased flexibility in power distribution between the speaker assemblies 32. In other embodiments the speaker assemblies 32 received within the first 14 and second 16 purifier assembly housings may be configured to receive power from batteries 36, 38 disposed in respective ones of the first 18 and second 20 end portions of the headband. For example, a speaker assembly 32 received within the first purifier assembly housing 14 may be configured to be powered by the batteries 36 within the first end portion 18 of the headgear 12, whilst a speaker assembly 32 received within the second purifier assembly housing 16 may be configured to be powered by batteries 38 within the second end portion 20 of the headgear 12.

The first 14 and second 16 purifier assembly housings of the head wearable air purifier 10 further comprise ambient air inlets 40, filter assemblies 42, outlet apertures 43 and airflow generators 44.

The ambient air inlet 40 of each of the first 14 and second 16 purifier assembly housings comprises a plurality of apertures through which air may be drawn into the interior of the purifier assembly housing 14, 16. Each filter assembly 42 is disposed within a respective purifier assembly housing 14, 16 between the ambient air inlet 40 and a respective airflow generator 44. Each filter assembly 42 comprises a filter material chosen to provide a desired degree of filtration of air to be provided to a wearer in use.

The airflow generators 44 each comprise a motor driven impeller which draw air from the respective ambient air inlet 40, through the respective filter assembly 42, and output air through the respective outlet apertures 43, of the purifier assembly housings 14, 16. The airflow generators 44 in the first 14 and second 16 purifier assembly housings are configured to receive power from all of the batteries 36, 38. Power transfer wiring (not shown) runs through the headgear 12 as described above in relation to the speaker assemblies 32. In other embodiments, the first purifier assembly housing may be configured to be powered by batteries 36 within the first end portion 18 of the headgear 12, whilst the airflow generator 44 in the second purifier assembly housing 16 may be configured to be powered by batteries 38 within the second end portion 20 of the headgear 10. This may allow at least one airflow generator 44 to be first in the event of failure of batteries 36, 38 in one of the first 18 and second 20 end portions.

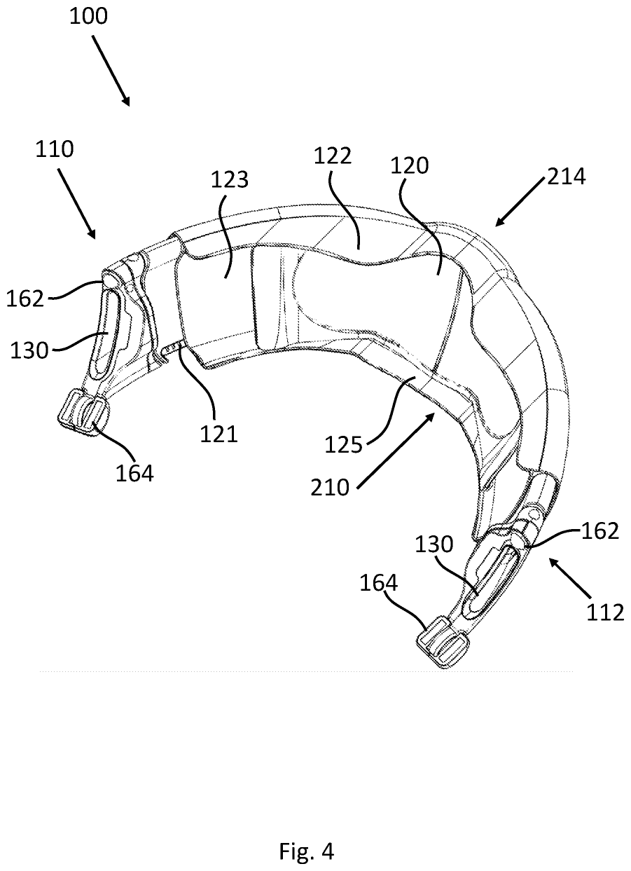

The nozzle assembly 100 is shown in isolation in FIG. 4.

The nozzle assembly 100 has first 106 and second 108 ends, and is curved between the first 106 and second 108 ends such that the nozzle assembly 100 is generally arcuate in form. The first 106 and second 108 ends comprise respective first 110 and second 112 end sections that connect to respective ones of the first 14 and second 16 purifier assembly housings, as will be described in more detail hereafter, and that connect to a midsection 102 of the nozzle assembly as will also be described in more detail hereafter.

When the nozzle assembly 100 is connected to the first 14 and second 16 purifier assembly housings, and the head wearable air purifier 10 is worn by a wearer, the nozzle assembly 100 is configured to extend in front of the face of the wearer, particularly the mouth and lower nasal region of the wearer, without contacting the face of the wearer.

The midsection 102 is generally hollow in form, and has an air outlet 120, which is defined by a mesh. Upper and lower surfaces of the midsection 102 comprise an upper flange 122 and a lower flange 125 respectively that extend rearwardly, for example toward a void defined between the first 110 and second 112 end sections, and serve to connect the mask body 200 to the nozzle assembly 100 and to inhibit unfiltered air entering a breathing zone adjacent a mouth and nasal region of a face of a wearer in use, particularly in conditions where the head wearable air purifier 10 is worn outside in a cross wind. The flanges 122, 125 may be formed of a resiliently deformable material to allow for some deformation of the midsection 102, and such that wearer comfort is provided in the event of accidental contact with a face of a wearer in use.

As shown in FIG. 4, the midsection 102 includes a main body 123 having a first end and a second end, and extension mechanisms 121 that connect the first end and second end of main body 123 to the respective first 110 and second 112 end sections of the nozzle assembly 100. The extension mechanisms 121 may take many forms, and may, for example, comprise a telescoping and/or ratchet mechanism that enables a length of the nozzle assembly 100 to be selectively increased or decreased by a wearer. The extension mechanisms 121 are hollow, and carry filtered airflow from the first 110 and second 112 end sections to the main body 123 of the midsection 102 in use. As the mask body 200, discussed below, may be connected to the nozzle assembly 100 in use, the wearer may be able to adjust the nozzle assembly 100 using the extension mechanisms 121 to achieve a secure and comfortable fit between the mask body 200 and the face of the wearer.

Each of the first 110 and second 112 end sections comprise a generally rigid body with an inlet 130, a magnetic detent 162 and a magnetic hinge 164. Each inlet 130 acts as an inlet for the nozzle assembly 100. The first 110 and second 112 end sections are hollow and carry filtered airflow from each of the inlets 130 to the extension mechanisms 121. Each of the magnetic detents 162 cooperates with upper magnets 124 on the purifier assembly housings 14 to retain the nozzle assembly 100 relative to the purifier assembly housings 14.

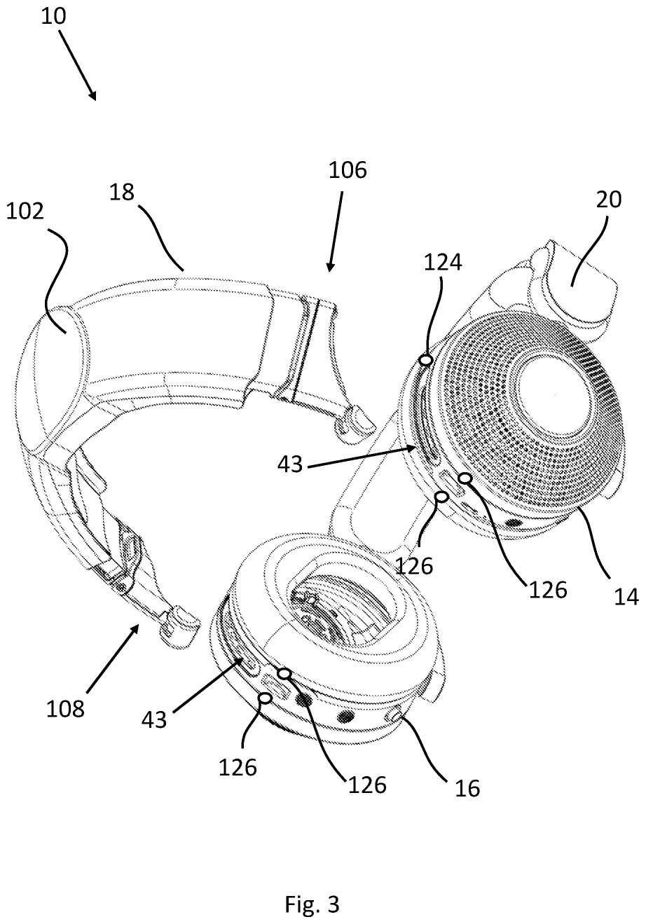

Each magnetic hinge 164 cooperates with corresponding lower magnets 126 (shown in FIG. 3) on the purifier assembly housings 14, 16 to releasably connect the end sections 110, 112, and hence the nozzle assembly 100, to the purifier assembly housings 14, 16. By providing magnetic detents 162 and hinges 164 the nozzle assembly 100 may be detachably connected to the air purifier assembly housings 14, 16. As a result, the mask body 200 may be attached and detached from the nozzle assembly 100 without removing the headgear 12 from a head of the wearer. This may increase the ease of use of the head wearable air purifier 10. Additionally, this may facilitate cleaning of the nozzle assembly 100.

The mask body 200 is shown in isolation in FIG. 5. The mask body 200 has a generally hollow curved shape such that a cavity 202 is defined within a concave side of the mask body 200. The mask body 200 is shaped to receive the mouth and nose of the wearer within the cavity 202.

In the embodiment of FIG. 5, the mask body 200 comprises a flow guide 201, a locating feature 203, a seal 205 and a deformable nose bridge having an embedded wire or strip 206. Although illustrated here as a deformable wire or strip, it will be appreciated that other embodiments that facilitate a deformable nose bridge are also envisaged As shown in FIGS. 6 and 8, the mask body 200 is connectable to the nozzle assembly by the locating feature 203 such that the convex side of the mask body 200 faces the air outlet 120 of the nozzle assembly 100 and the concave side of the mask body 200 faces away from the air outlet 120 of the nozzle assembly 100. When connected to the nozzle assembly 100, as shown in FIGS. 6 to 8, the mask body 200 overlies the air outlet 120 of the nozzle assembly 100 such that the cavity 202 of the mask body 200 is in fluid communication with the air outlet 120.

The mask body 200 is constructed of a layer of open cell foam between two layers of fabric. The open cell foam and fabric layers act as a filter to filter air passing through the mask body 200. The mask body 200 has a thickness and the foam has a pore size that result in a pressure drop of the airflow between the air outlet 120 and the cavity 202 of between 400 and 500 pascals. Such a pressure drop may ensure sufficient air reaches the cavity 202.

The flow guide comprises 201 four projections that project from the convex side of the mask body 200: a lower projection 207 and an upper projection 209 that extend substantially parallel across the mask body 200, and a pair of side projections 211 that extend substantially vertically and join the upper projection 209 to the lower projection 207. The side projections 211 project further from the mask body 200 than the upper 209 and lower 207 projections.

The upper 209 and lower 207 projections are shaped such that when the mask body 200 is connected to the nozzle assembly 100, the upper 209 and lower 207 projections contact the nozzle assembly 100 outside of the air outlet 120 such that the top and the bottom of the air outlet 120 are surrounded by the upper 209 and lower 207 projections. The side projections 211 are shaped such that they overlie the sides of the air outlet 120. This enables the flow guide 201 to inhibit the airflow emitted from the air outlet 120 from leaking around the mask body 200 when the mask body 200 is connected to the nozzle assembly 100.

The flow guide 201 is constructed from a single piece of silicone rubber having a Shore A Durometer of 80. As a result, the flow guide 201 may be able to conform to the shape of the nozzle assembly 100, which may increase the proportion of the airflow entering the cavity, whilst also being sufficiently rigid to not be deformed by the airflow, which may reduce the proportion of the airflow entering the cavity. A material having a different Shore A Durometer may nevertheless be used, and good performance may still be achieved with a material having a Shore A Durometer of between 70 and 90.

The lower projection 207 provides a secondary function as a further locating feature 208. When the mask body 200 is connected to the nozzle assembly 100, the lower projection 207 contacts a further portion 210 of the nozzle assembly 100 to locate the mask body 200 relative to the nozzle assembly 100. In the example nozzle assembly 100 of FIG. 4, the further portion 210 comprises the lower flange 125. In other embodiments the further portion 210 may comprise other portions of the nozzle assembly 100.

The locating feature 203 comprises a pair of opposing arms. A first arm 213 has the form of a projection that projects from the mask body 200 above a central section 215 of the upper projection 209 of the flow guide 201 and extends substantially parallel to the central section 215. A second arm is defined by the central section 215 of the upper projection 209. A gap between the pair of opposing arms may be considered a slot. The first arm 213 comprises the same silicone rubber as the flow guide 201. In use, a portion 214 of the nozzle assembly 100 is inserted between the first 213 and second arms such that the arms form an interference fit with the portion 214 of the nozzle assembly 100 to connect the mask body 200 to the nozzle assembly 100. In the example nozzle assembly 100 of FIG. 4, the portion 214 comprises the upper flange 122. In other embodiments the portion 214 may comprise other portions of the nozzle assembly 100. In other embodiments alternative fastening mechanisms such as pairs of magnets or press studs may be used.

The seal 205 extends around the perimeter of the mask body 200 and is for sealing with a face of the wearer in use. The seal 205 comprises a single piece of silicone rubber having a Shore A Durometer of 40. A material having a different Shore A Durometer may nevertheless be used, and good performance may still be achieved with a material having a Shore A Durometer of between 30 and 50.

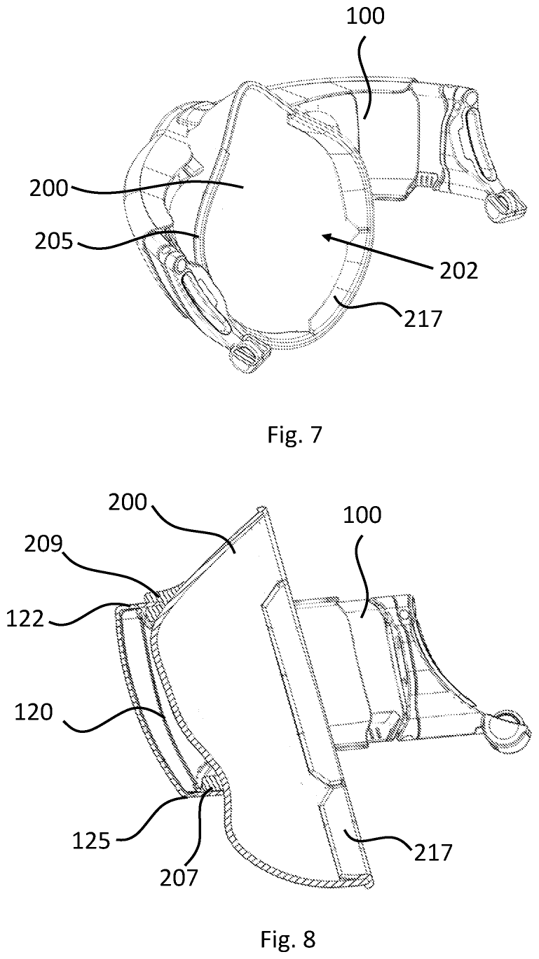

Turning now to FIG. 7, the seal 205 comprises multiple tabs 217 that extend inwardly from the perimeter of the mask body 200. The tabs 217 enable the wearer to insert a filter media into the concave side of the mask body 200 and retain the filter media between the tabs 217 and the concave side of the mask body 200.

The deformable nose bridge 206, illustrated schematically in FIG. 5, is embedded within the fabric layer of the mask body 200 in a location such that the deformable nose bridge 206 overlies the nose of the wearer in use. In the embodiment of FIG. 5, the deformable nose bridge 206 comprises at least one metal strip or wire coated in plastic and supports the shape of the mask body 200.

In use, the head wearable air purifier 10 may be used with or without the mask body 200 connected to the nozzle assembly 100.

When used without the nozzle assembly 100 attached, the head wearable air purifier 10 is located on a head of a wearer such that the first 14 and second 16 air purifier assemblies are located over respective ears of the wearer, and the nozzle assembly 100 extends in front of a mouth and lower nasal region of the face of the wearer, without contacting the face of the wearer. The airflow generators 44 are operable to draw air through the ambient air inlet 40 of each of the first 14 and second 16 purifier assembly housings, through the filter assemblies 42, and expel filtered airflow through the outlet apertures 43 into the inlets 130 of the nozzle assembly 100 and through the first 110 and second 112 end sections toward the midsection 102. Filtered airflow travels through the midsection 102 as first and second filtered airflows, and is delivered from the nozzle assembly 100, via the air outlet 120, to the wearer of the head wearable air purifier 10.

To connect the mask body 200, the wearer removes the nozzle assembly 100 from the air purifier assembly housings 14, 16 by disconnecting the magnetic detents 162 and hinges 164 and fits the mask body 200 to the nozzle assembly 100 by pressing the upper flange 122 of the nozzle assembly 100 into the locating feature 203 of the mask body 200 and bringing the lower projection 207 of the mask body 200 into contact with the lower flange 125 of the nozzle assembly 100. The wearer then reconnects the nozzle assembly 100 to the air purifier assembly housings 14, 16 using the magnetic detents 162 and hinges 164.

When used with the nozzle assembly 100 attached, the head wearable air purifier 10 is located on a head of a wearer such that the first 14 and second 16 air purifier assembly housings are located over respective ears of the wearer, the nozzle assembly 100 extends in front of a mouth and lower nasal region of the face of the wearer, and the mask body 200 fits over the mouth and nose of the wearer. A seal is formed between the seal 205 of the mask body 200 and the face of the wearer. The airflow generators 44 are operable to draw air through the ambient air inlet 40 of each of the first 14 and second 16 purifier assembly housings, through the filter assemblies 42, and expel filtered airflow through the outlet apertures 43 into the inlets 130 of the nozzle assembly 100 and through the first 110 and second 112 end sections toward the midsection 102. Filtered airflow travels through the midsection 102 as first and second filtered airflows, and is emitted from the nozzle assembly 100 via the air outlet 120. The emitted air then passes through the mask body 200 and into the cavity where it is received by the mouth and nose of the wearer.

The speaker assemblies 32 may provide audio data to a wearer, for example in the form of music and the like, and alternatively or additionally may provide noise cancellation for noise caused by operation of the airflow generators 44.

By having a mask body 200 detachably connected to the nozzle assembly 100, the head wearable air purifier 10 may be used with or without the mask body 200 attached. This may be beneficial as with the mask body 200 attached a greater proportion of the airflow emitted from the air outlet 120 may be provided to the mouth and/or nose of the wearer relative to a non-contact arrangement. Additionally, as the mask body 200 comprises a filter, air exhaled by the wearer may be filtered before being released into the surrounding environment. This may reduce the risk of spread of pathogens from the wearer to the surrounding environment relative to a non-contact arrangement. Alternatively, operating the head wearable air purifier 10 with the mask body 200 removed may increase the comfort of the wearer as the nose and mouth of the wearer may not be covered.

Although depicted here with two airflow generators 44, each feeding one end of the nozzle assembly 100, it will be appreciated that in alternative embodiments only a single airflow generator 44 may be provided, which may either feed both or one of the ends of the nozzle assembly 100.

Although the headgear 12 is described above as having a headband form, the headgear 12 may equally have the form of other headgear such as a hat or a helmet. Additionally, although the purifier assembly housings 14, 16 are described above as housing a speaker assembly 32, the speaker assembly 32 may be omited.

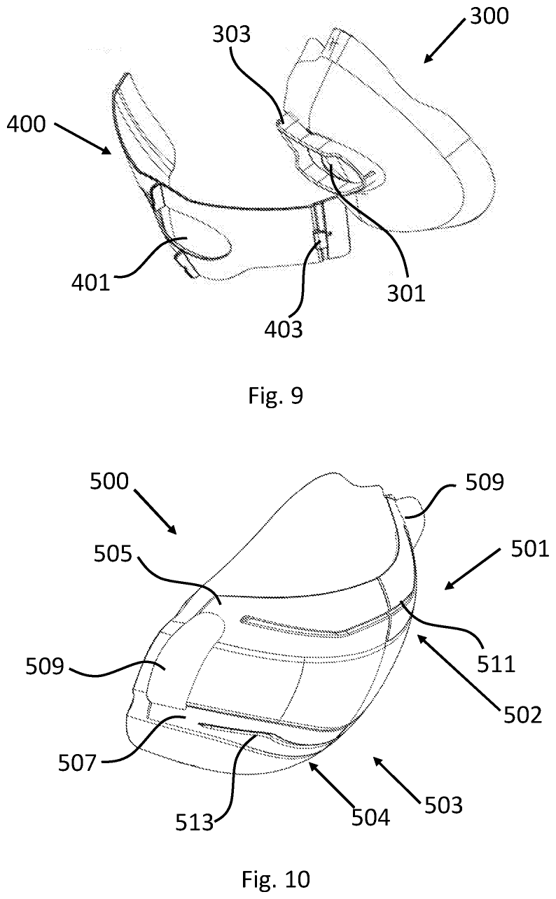

FIG. 9 shows a further example of a mask body 300 and a connection plate 400 for connecting the mask body 300 to the nozzle assembly 100. The mask body 300 is similar to that described above with two exceptions.

Firstly, the mask body 300 comprises a central oval shaped aperture 301 with a width of around 20-60 mm and a height of around 20-40 mm. When connected to the nozzle assembly 100, the airflow emitted by the air outlet 120 of the nozzle assembly 100 is received by the aperture 301 and allowed to pass into the cavity of the mask body without passing through the material comprising the mask body 300. As a result, the proportion of the airflow generated by the airflow generators 44 entering the cavity may be increased relative to an arrangement without the aperture 301. This may enable the amount of airflow generated to be reduced whilst maintaining the amount of filtered airflow reaching the cavity, which may reduce the energy draw from the batteries of the head wearable air purifier and increase the operational duration of the head wearable air purifier 10. An aperture 301 having a different geometry may nevertheless be used, and good performance may still be achieved with an aperture 301 having a diameter of at least 10 mm.

Secondly, the mask body 301 comprises an upstanding ridge 303 that projects from the convex side of the mask body 300 and surrounds the outlet 301 of the mask body 300. The upstanding ridge 303 is for connecting the mask body to the connection plate 400.

The connection plate 400 comprises a generally elongated and arcuate body with a central oval aperture 401 and clips 403 at either end. The arcuate body is proportioned such that when connected to the nozzle assembly 100, the arcuate body overlies the outlet 120 of the nozzle assembly 100 such that the majority of the emitted airflow passes through the aperture 401 of the connection plate 400. The aperture 401 is similar in size to the upstanding ridge 303 of the mask body 300 such that the upstanding ridge 303 may be inserted into the aperture 401 and a friction fit formed to connect the mask body 300 to the connection plate 400. The clips 403 clip the connection plate 400 to the nozzle assembly 100.

To connect the mask body 300 to the nozzle assembly, the upstanding ridge 303 of the mask body 300 is inserted into the aperture 401 of the connection body 400 and the connection body 400 is clipped to the nozzle assembly 100 using the clips 403. Thereby, in use, the airflow emitted by the nozzle assembly 100 passes through the aperture in the connection plate 401, the aperture in the mask body 301 and into the cavity of the mask body 300.

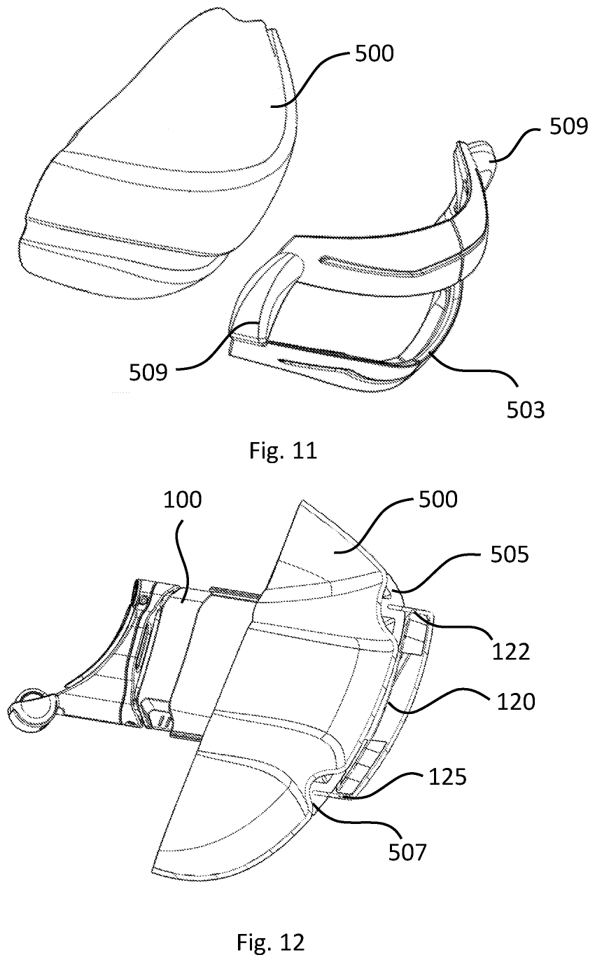

FIGS. 10, 11 and 12 show a further example of a mask body 500. The mask body 500 is similar to the mask body of FIGS. 5 to 7 with the exception of the flow guide 501, the locating feature 502 and the further locating feature 504.

The flow guide 501 comprises a frame 503 attached to the convex side of the mask body 500 and has an upper portion 505, a lower portion 507 and a pair of side portions 509 that together form a closed shape.

The upper 505 and lower 507 portions are shaped such that when the mask body 500 is connected to the nozzle assembly 100, the upper 505 and lower 507 portions contact the nozzle assembly 100 outside of the air outlet 120 such that the top and the bottom of the air outlet 120 are surrounded by the upper 505 and lower 507 portions. The side portions 509 are shaped such that they overlie the sides of the air outlet 120.

The upper portion 505 comprises a slot 511 such that the upper portion 505 may function in use as a locating feature 502. In use, a portion 214 of the nozzle assembly 100 is inserted into the slot 511 such that an interference fit is formed to connect the mask body 500 to the nozzle assembly 100. In the nozzle assembly 100 of FIG. 4, the portion 214 of the nozzle assembly 100 comprises the upper flange 122.

The lower portion 507 comprises a further slot 513 such that the lower portion 507 may function in use as a further locating feature 504. In use, a further portion 210 of the nozzle assembly 100 is inserted into the further slot 513 such that an interference fit is formed to connect the mask body 500 to the nozzle assembly 100. In the nozzle assembly 100 of FIG. 4, the further portion 210 of the nozzle assembly 100 comprises the lower flange 125.

1. A head wearable air purifier comprising:
a headgear;
an air purifier assembly supported by the headgear, the air purifier assembly comprising a filter and an airflow generator for generating an airflow through the filter;
a nozzle assembly configured to extend in front of a face of a wearer in use, the nozzle assembly comprising an inlet aperture configured to receive a filtered airflow from the air purifier assembly, and an air outlet for emitting the filtered airflow from the nozzle assembly; and
a mask body detachably connected to the nozzle assembly, the mask body defining a cavity for receiving a mouth and/or nose of the wearer, the cavity in fluid communication with the air outlet.

2. The head wearable air purifier as claimed in claim 1, wherein, when the mask body is disconnected from the nozzle assembly, the nozzle assembly is configured such that the air outlet delivers the filtered airflow to a mouth and/or nasal region of the wearer in use without contacting the face of the wearer.

3. The head wearable air purifier as claimed in claim 1, wherein the mask body comprises a further filter.

4. The head wearable air purifier as claimed in claim 3, wherein the further filter is removable.

5. The head wearable air purifier as claimed in claim 1, wherein the mask body comprises a locating feature configured to detachably connect to the nozzle assembly.

6. The head wearable air purifier as claimed in claim 5, wherein the locating feature is configured to form an interference fit with a portion of the nozzle assembly to detachably connect the locating feature to the nozzle assembly.

7. The head wearable air purifier as claimed in claim 5, wherein the nozzle assembly comprises a further locating feature configured to contact the nozzle assembly when the locating feature is connected to the nozzle assembly.

8. The head wearable air purifier as claimed in claim 7, wherein the further locating feature is configured to detachably connect to the nozzle assembly.

9. The head wearable air purifier as claimed in claim 8, wherein the further locating feature is configured to form an interference fit with a further portion of the nozzle assembly to detachably connect the further locating feature to the nozzle assembly.

10. The head wearable air purifier as claimed in claim 1, wherein the mask body comprises a flow guide for inhibiting the airflow emitted from the air outlet from leaking around the mask body.

11. The head wearable air purifier as claimed in claim 10, wherein the flow guide comprises a Shore A Durometer of between 70 and 90.

12. The head wearable air purifier as claimed in claim 1, wherein the mask body comprises a seal for sealing with a face of the wearer in use.

13. The head wearable air purifier as claimed in claim 12, wherein the seal comprises a Shore A Durometer of between 30 and 50.

14. The head wearable air purifier as claimed in claim 1, wherein the mask body comprises an open cell foam.

15. The head wearable air purifier as claimed in claim 1, wherein the mask body is configured such that a pressure drop of the airflow between the air outlet and the cavity is between 400 and 500 pascals in use.

16. The head wearable air purifier as claimed in claim 1, wherein the mask body comprises at least one tab configured to retain a filter media in use.

17. The head wearable air purifier as claimed in claim 16, wherein the tab comprises a shore A durometer of between 30 and 50.

18. The head wearable air purifier as claimed in claim 1, wherein the nozzle assembly is detachably connected to the air purifier assembly.

19. The head wearable air purifier as claimed in claim 1, wherein the nozzle assembly comprises an extension mechanism for controlling a length of the nozzle assembly.
